(19) United States
(12) Patent Application Publication
(10) Pub. No.: US 2019/0385073 A1
(43) Pub. Date: Dec. 19, 2019

(54) VISUAL RECOGNITION VIA LIGHT WEIGHT NEURAL NETWORK

(71) Applicant: Microsoft Technology Licensing, LLC, Redmond, WA (US)

(72) Inventors: Yandong Guo, Bellevue, WA (US); Lei Zhang, Bellevue, WA (US)

(21) Appl. No.: 16/012,424

(22) Filed: Jun. 19, 2018

(51) Int. Cl. G06N 5/04; G06N 3/08; G06F 17/16; G06N 3/04; G06K 9/00; G06K 9/62

(52) U.S. Cl. CPC G06N 5/046; G06N 3/082; G06K 9/6267; G06N 3/0472; G06K 9/00288; G06F 17/16

(57) ABSTRACT

Systems and methods for visual recognition via light weight neural network are disclosed. A method includes accessing an input matrix. The method includes processing the input matrix through a plurality of convolution layers from a neural network architecture, each convolution layer including a convolution layer kernel, to generate a processed matrix, the convolution layer kernel being a first square, a side dimension of the first square being an integer greater than or equal to two. The method includes processing, at the processing hardware, the processed matrix through at least one squeeze layer, the at least one squeeze layer including a squeeze layer kernel, to generate an output matrix, the squeeze layer kernel being a second square with a side dimension of one, the at least one squeeze layer replacing at least one convolution layer from the neural network architecture. The method includes providing a representation of the output matrix.

### BACKGROUND

In some implementations, visual recognition (e.g., facial recognition or object recognition) via neural network requires high processing power and a large amount of memory to run in real-time or near real-time. Techniques for visual recognition via neural network that can run in near real-time with lower processing power or lower memory (e.g., on an edge device, such as a web camera or a mobile phone) may be desirable.

### BRIEF DESCRIPTION OF THE DRAWINGS

Some embodiments of the technology are illustrated, by way of example and not limitation, in the figures of the accompanying drawings.

FIG. 1 illustrates an example system in which visual recognition via neural network may be implemented, in accordance with some embodiments.

FIG. 2 illustrates a flow chart for an example visual recognition method, in accordance with some embodiments.

FIG. 3 illustrates an example neural network diagram for visual recognition, in accordance with some embodiments.

FIG. 4 illustrates an example building block for residual learning.

FIG. 5 is a block diagram illustrating components of a machine able to read instructions from a machine-readable medium and perform any of the methodologies discussed herein, in accordance with some embodiments.

### SUMMARY

The present disclosure generally relates to machines configured to provide neural networks, including computerized variants of such special-purpose machines and improvements to such variants, and to the technologies by which such special-purpose machines become improved compared to other special-purpose machines that provide technology for neural networks. In particular, the present disclosure addresses systems and methods for visual recognition via neural network.

According to some aspects of the technology described herein, a system includes processing hardware and a memory. The memory stores instructions which, when executed by the processing hardware, cause the processing hardware to perform operations. The operations include accessing an input matrix. The operations include processing the input matrix through a plurality of convolution layers, each convolution layer including a convolution layer kernel, to generate a processed matrix, the convolution layer kernel being a first square, a side dimension of the first square being an integer greater than or equal to 2. The operations include processing the processed matrix through at least one squeeze layer, the at least one squeeze layer including a squeeze layer kernel, to generate an output matrix, the squeeze layer kernel being a second square with a side dimension of 1. The operations include providing a representation of the output matrix.

According to some aspects of the technology described herein, a machine-readable medium stores instructions which, when executed by one or more machines, cause the one or more machines to perform operations. The operations include accessing an input matrix. The operations include processing the input matrix through a plurality of convolution layers, each convolution layer including a convolution layer kernel, to generate a processed matrix, the convolution layer kernel being a first square, a side dimension of the first square being an integer greater than or equal to 2. The operations include processing the processed matrix through at least one squeeze layer, the at least one squeeze layer including a squeeze layer kernel, to generate an output matrix, the squeeze layer kernel being a second square with a side dimension of 1. The operations include providing a representation of the output matrix.

According to some aspects of the technology described herein, a method includes accessing an input matrix. The method includes processing the input matrix through a plurality of convolution layers, each convolution layer including a convolution layer kernel, to generate a processed matrix, the convolution layer kernel being a first square, a side dimension of the first square being an integer greater than or equal to 2. The method includes processing the processed matrix through at least one squeeze layer, the at least one squeeze layer including a squeeze layer kernel, to generate an output matrix, the squeeze layer kernel being a second square with a side dimension of 1. The method includes providing a representation of the output matrix.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

As set forth above, visual recognition (e.g., facial recognition or object recognition) via neural network requires high processing power and a large amount of memory to run in real-time or near real-time. Techniques for visual recognition via neural network that can run in near real-time with lower processing power or lower memory (e.g., on an edge device, such as a web camera or a mobile phone) may be desirable. As used herein, near real-time may include within a threshold time period (e.g., within one second, within 10 seconds, within one minute, within 5 minutes, etc.).

Some aspects of the technology described herein are directed to solving the technical problem of visual recognition in near real-time on an edge device. According to some implementations, the solution includes accessing, using an edge device, an input matrix. The input matrix may represent an input image to which visual recognition is to be applied. The edge device processes the input matrix through a plurality of convolution layers to generate a processed matrix. Each convolution layer includes a convolution layer kernel. The convolution layer kernel is a first square. A side dimension of the first square is an integer greater than or equal to 2. The edge device processes the processed matrix through at least one squeeze layer to generate an output matrix. The squeeze layer includes a squeeze layer kernel. The squeeze layer kernel is a second square with a side dimension of 1. The edge device provides a representation of the output matrix. The output matrix may correspond to an identification of a face or an object in the input image.

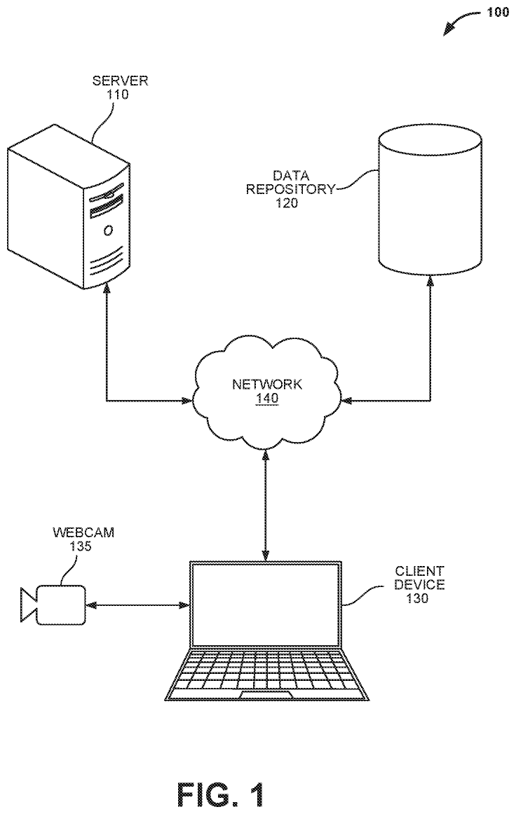

FIG. 1 illustrates an example system 100 in which visual recognition via neural network may be implemented, in accordance with some embodiments. As shown, the system 100 includes a server 110, a data repository 120, and a client device 130 connected to one another via a network 140. The network 140 includes one or more of the Internet, an intranet, a local area network, a wide area network, a wired network, a wireless network, a cellular network, a WiFi network, and the like. The client device 130 is coupled with a webcam 135. The webcam 135 is an edge device, which may have limited processing power and limited memory (compared to a full laptop computer, desktop computer, or server).

The client device 130 may be a laptop computer, a desktop computer, a mobile phone, a tablet computer, a smart television with a processor and a memory, a smart watch, and the like. The client device 130 is coupled with the webcam 135. The webcam may have its own processor(s) and memory, which may be less powerful than those of the full client device 130. The data repository 120 may store a plurality of images, which may be matched to an image captured from the client device 130 using visual recognition technique(s). The data repository 120 may be implemented as a database or any other data storage unit.

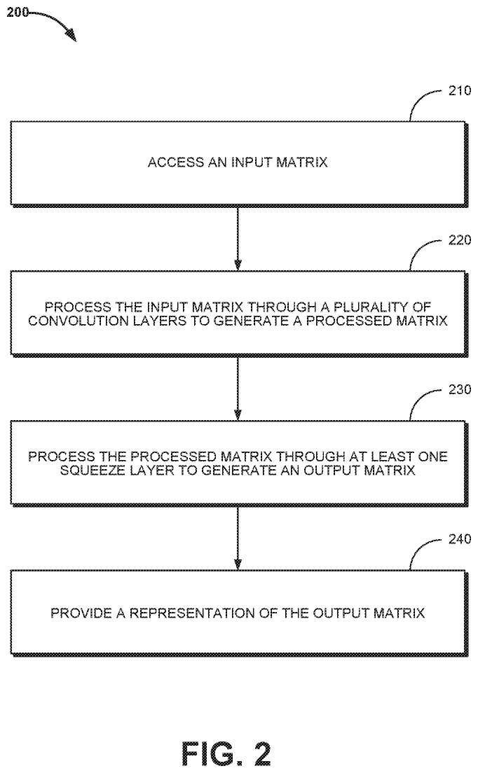

In some schemes, the client device 130 captures (e.g., using the webcam 135) an image and provides the captured image to the server 120. The server 120 then applies a visual recognition technique to match the captured image to image(s) stored in the data repository 120. However, these schemes require network access and require usage of a server with high processing power and a large amount of memory. Some techniques described herein allow for visual recognition to take place on an edge device, such as the webcam 135 (or, alternatively, a mobile phone or tablet computer) with limited processing power and memory. For example, the method described in conjunction with FIG. 2 may be implemented using the webcam 135 or another edge device.

FIG. 2 illustrates a flow chart for an example visual recognition method 200, in accordance with some embodiments. The visual recognition method 200 is described herein as being implemented at the webcam 135. However, in alternative embodiments, the visual recognition method may be implemented at any other edge device, such as a mobile phone, a tablet computer, a laptop computer with limited processing power or memory, and the like. In some cases, the edge device may be replace with a non-edge device, such as a full scale server or laptop/desktop computer. For example, the method 200 may be implemented at the client device 130 or at the server 110, instead of at the webcam 135, as described here.

At operation 210, the webcam 135 accesses an input matrix. The input matrix may be stored in a local memory of the webcam 135 and may be accessed by processor(s) of the webcam 135. The input matrix may represent an input image to which visual recognition is to be applied. The input matrix may have a width w, a height h, and a depth cᵢₙ, where w, h, and cᵢₙ are positive integers. In some examples, the webcam 135 captures an image to which visual recognition is to be applied and generates the input matrix based on the captured image.

At operation 220, the webcam 135 processes the input matrix through a plurality of convolution layers from a neural network architecture to generate a processed matrix. The neural network architecture may be a preselected convolution neural network. The neural network architecture may be used for facial recognition or other image recognition. Each convolution layer includes a convolution layer kernel having dimensions k*k. In other words, the convolution layer kernel may be a first square with a side dimension of k, where k is an integer greater than or equal to 2. In some cases, the webcam 135, for each convolution layer: for each k*k block in the input matrix, computes a dot product of the weights indicated in the convolution layer kernel and the k*k block. The computed dot product is provided for storage in a matrix to be provided to the next layer.

At operation 230, the webcam 135 processes the processed matrix through squeeze layer(s) to generate an output matrix. The squeeze layer(s) replace at least one convolution layer from the neural network architecture. For example, the squeeze layer(s) may replace the last 1, 2, 3, etc., layers of the neural network architecture. The squeeze layer(s) include a squeeze layer kernel having dimensions 1*1. In other words, the squeeze layer kernel is a second square with a side dimension of 1. In some cases, the squeeze layer(s) include exactly one squeeze layer. Alternatively, the squeeze layer(s) may include multiple squeeze layers. The squeeze layer(s) may follow the plurality of convolution layers. An example of the multiple stages is described below in conjunction with Table 2.

At operation 240, the webcam provides a representation of the output matrix. In some cases, the input matrix (from operation 210) and the output matrix have the same width w, the same height h, and different depths. The depth of the output matrix may be cₒᵤₜ, where cₒᵤₜ is a positive integer that is different from the depth of the input matrix cᵢₙ. In some cases, the input matrix corresponds to an image. The output matrix corresponds to an identification, based on data in the data repository 120, of a person or an object depicted in the image. In some cases, the webcam 135 (or the client device 130 or the server 110) identifies, based on the output matrix and information stored in the data repository 120, a person or an object depicted in the image which corresponds to the input matrix.

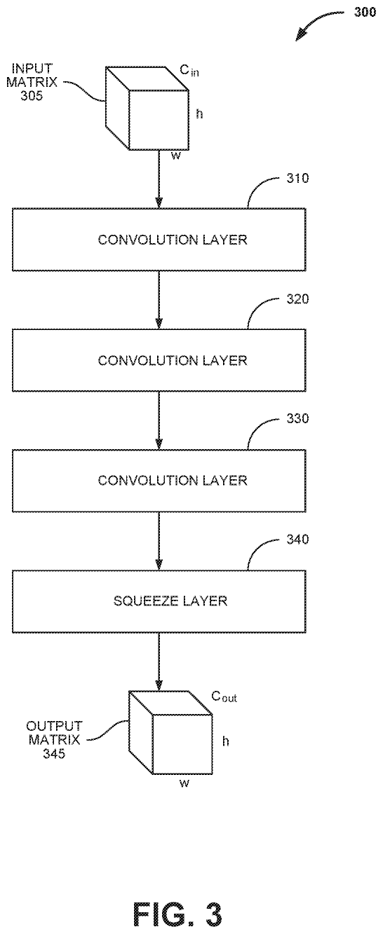

FIG. 3 illustrates an example neural network diagram 300 for visual recognition, in accordance with some embodiments. A neural network corresponding to the neural network diagram 300 may be implemented at an edge device, such as the webcam 135, or at a non-edge device. While the neural network diagram 300 is shown to include three convolution layers and one squeeze layer, it should be noted that any number of convolution layer(s) or squeeze layer(s) may be used with the technology described herein.

As shown in FIG. 3, an input matrix 305 has dimensions w*h*cᵢₙ. The input matrix 305 may correspond to an image captured by the webcam 135. The input matrix 305 is provided to a first convolution layer 310, which processes the input matrix 305 and provides its output to a second convolution layer 320. The second convolution layer 320 processes the output from the first convolution layer 310 and provides an output to a third convolution layer 330. The third convolution layer 330 processes the output from the second convolution layer 320 and provides an output to the squeeze layer 340. The squeeze layer 340 processes the output from the third convolution layer 330 and generates the output matrix 345. As shown, the output matrix 345 has dimensions w*h*cₒᵤₜ. In some cases, w, h, cᵢₙ, and cₒᵤₜ are integers, and cₒᵤₜ is different from cᵢₙ. The output matrix 345 may be used to identify, using the data repository 120, a person or an object in the image captured by the webcam 135.

In one example, the convolution layers 310, 320, and 330 are the first three layers of a convolution neural network architecture. The squeeze layer 340 replaces the fourth layer of the convolution neural network architecture, using squeeze technology in place of convolution technology. As a result, a neural network corresponding to the neural network architecture 300 uses less computational resources (e.g., processor(s), memory) than the full convolution neural network architecture, and can be more easily implemented on an edge device.

In some cases, each of the convolution layers 310, 320, and 330 processes its input using a k*k kernel, where k is an integer greater than or equal to 2. A dot product is calculated between the k*k kernel and every k*k block in the input. The squeeze layer 340 processes its input using a 1*1 kernel. One example of the operation of the convolution layers and the squeeze layer is described below in conjunction with Table 2.

According to some embodiments, the final squeeze layer 340 replaces a convolution layer because it uses less processing and memory resources than the convolution layer. Replacing the convolution layer with the squeeze layer 340 allows the diagrammed neural network to run in near real-time on an edge device.

As used herein, the squeeze layer 340 has fewer parameters than the convolution layers 310-330. The squeeze layer 340 accomplishes this by using smaller filters (e.g., 1×1 filters rather than 3×3 filters), decreasing the number of input channels to larger filters, and downsampling late in the network so that the convolution layers have large activation maps. The squeeze layer 340 may include a fire module. The fire module has a squeeze submodule that includes only 1×1 filters and an expand submodule that includes a combination of 1×1 and 3×3 filters. This limits the number of input channels to the larger 3×3 filters. It should be noted that 1×1 and 3×3 filters are used here as examples, and may be replaced with other filter sizes.

Table 1 illustrates an example convolution scheme for visual recognition. In Table 1 and Table 2, w represents the width, h represents the height, d represents the depth, and k represents a side dimension of a kernel square.

TABLE 1
Convolution Scheme.

Input size: w * h * d
Operators: d * k * k, there are n operators (filters)
Output size: w * h * n
The number of operations is w * h * d * k * k * n

Table 2 represents a squeezed approach for visual recognition.

TABLE 2
Squeezed Approach.

Stage 1 Operators: 1 * 1 * d, there are m operations, m < d
Stage 1 output: w * h * m
Stage 2 Operators: m * k * k, there are n/2 such operations, m * 1 * 1,
there are n/2 such operations.
Stage 2 output: n * w * h
The total number of operations is: w * h * d * m (stage 1) + w * h * m * k
* k * n/2 + w * h * m * n/2 (stage 2)

In one example, d is 256, k is 3, n is 512, and m is 64. In this example, the number of convolution operations is w*h*9*256*512. In the squeezed case, the number of operations is w×h×(256×64+64×9×256+64×256), which is much smaller than that for the convolution case.

One idea describe herein is to use the squeezed operation to replace selected layers of a residual network (ResNet). The replacing of selected layers is one feature of the technology described herein.

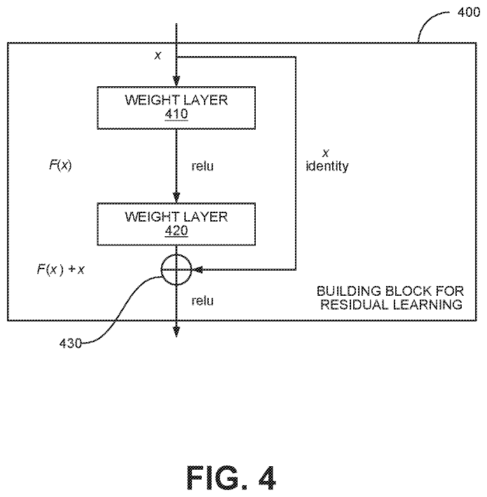

FIG. 4 illustrates an example building block 400 for residual learning in ResNet. As shown, an input x is provided to a weight layer 410, which outputs F(x). The relu function is applied to the output of the weight layer 410, and the result is provided to a weight layer 420. At position 430, the output of the weight layer 420 is combined with an identity function on the input of the building block 400 to result in F(x)+x. The relu function is applied to F(x)+x to generate an output of the building block 430. As used herein, the relu function includes relu(a)=max(0,α).

Some aspects are directed to techniques to build fast and accurate neural network for face recognition on the edge.

The residual neural network (ResNet) has demonstrated cutting-edge performance in terms of visual recognition tasks. The ResNet shares the same core spirit of deep convolutional neural network, which is to process the input image with a stack of sequential operations, while has the unique design of residual operation, shown as FIG. 4. Multiple of the residual operations shown in FIG. 4 may be included in different versions of ResNet.

The squeeze layer—SqueezeNet—is used to reduce the number of parameters for the convolutional layer. The intuition of the SqueezeNet is as follows. Suppose the input of a certain convolutional layer is a tensor with the size w×h×d, and this convolutional layer has n filers of the size d×k×k. Then this convolutional layer could be replaced by a module called a “squeeze-expand” block, which has fewer parameters yet similar performance. However, the network structure (all the layers are the “squeeze-expand” block) might. In some cases, not have good performance for face recognition.

A bit more details recaps the fundamental idea of SqueezeNet. The “squeeze-expand” block has two operations. First, a convolutional layer with m filters (m<d, filter size 1×1×d) is applied. This layer is called “squeeze.” Second, another convolutional layer are applied, called “expand.” Since the second (“expand”) layer has the input tensor of the size w×h×m, which is much smaller than the original input, the number of parameters is reduced.

In some implementations, ResNet is used as the backbone model, and the last stage of ResNet is replaced with SqueezeNet to reduce the model size. The classification vector-centered cosine similarity regularization may, in some cases, be applied to further improve the performance.

According to some aspects, there are several technologies involved in a convolution deep neural network-based visual recognition system. In one example, more layers may be added with residual technology. This leads to higher accuracy, but has the downsides of a larger network and slower performance. In another example, squeezing technology is used. This leads to lower accuracy, but has a smaller and faster (in terms of execution time for a given amount of processing and memory resources) network. In some aspects, a regularizer (for example, as described below) improves the accuracy without slowing down the performance. Some aspects are directed to a combination of the residual (e.g. convolution) layer(s), the squeezing layer(s), and the regularization technology.

Some aspects are directed to solving the problem of training a large-scale face identification model with imbalanced training data. This problem naturally exists in many real scenarios including large-scale celebrity recognition, movie actor annotation, and the like. The solution may include building a face feature extraction model, and improving its performance, especially for the persons with very limited training samples, by introducing a regularizer to the cross entropy loss for the multinomial logistic regression (MLR) learning. This regularizer encourages the directions of the face features from the same class to be close to the direction of their corresponding classification weight vector in the logistic regression.

The solution may include representation learning. In representation learning, one builds a face representation model using all the training images from the base set.

Some aspects train the face representation model with a supervised learning framework considering persons' identifiers as class labels. The cost function that is used is shown as Equation 1.

[symbol]

= [symbol] ₛ+λ [symbol] ₐ Equation 1

In Equation 1, [symbol] ₛ is the standard cross entropy loss used for a Softmax layer, while [symbol] ₐ is our proposed loss used to improve the feature discrimination and generalization capability, with the balancing coefficient λ.

More specifically, we recap the first term, cross entropy [symbol] ₛ as shown in Equation 2.

$${ℒ}_{s} = - {\sum }_{n} {\sum }_{k} {t}_{k , n} log {p}_{k} ( {x}_{n} ) \qquad Equation 2$$

In Equation 2, t_{k, n}∈{0, 1} is the ground truth label indicating whether the n^{th} image belongs to the k^{th} class, and the term pₖ(xₙ) is the estimated probability that the image xₙ belongs to the k^{th} class, defined as, shown in Equation 3.

$${p}_{k} ( {x}_{n} ) = \frac{exp ( {w}_{k}^{T} φ ( {x}_{n} ) )}{{\sum }_{i} exp ( {w}_{k}^{T} φ ( {x}_{n} ) )} \qquad Equation 3$$

In Equation 3, wₖ is the weight vector for the k^{th} class, and ϕ(⋅) denotes the feature extractor for image xₙ. Some aspects use a standard residual network with 34 (or another number of) layers as the feature extractor ϕ(⋅), and use the last pooling layer as the face representation. The standard residual network may be used due to its tradeoff between prediction accuracy and model complexity. However, the technique described herein is general enough to be extended to deeper network structures. In some cases, one may set the bias term bₖ=0. In some cases, removing the bias term from the standard Softmax layer might not affect the performance. However, this may lead to a better understanding of the geometry property of the classification space.

The second term [symbol] ₐ of the cost function shown in Equation 1 is calculated as shown in Equations 4 and 5.

$$\begin{matrix}{w}_{k}^{′} ← {w}_{k} & Equation 4 \\ {ℒ}_{a} = - {\sum }_{k} {\sum }_{i ϵ {C}_{k}} \frac{{w}_{k}^{′ T} φ ( {x}_{i} )}{{‖ {w}^{′} ‖}_{2} {‖ φ ( {x}_{i} ) ‖}_{2}} & Equation 5\end{matrix}$$

One may set the parameter vector w′ₖ to be equal to the weight vector wₖ. This loss term encourages the face features belong to the same class to have similar direction as the associated classification weight vector wₖ^{T}. This term is called Classification vector-centered Cosine Similarity (CCS) loss. Calculating the derivative with respect to ϕ(xᵢ), results in Equation 6.

$$\frac{\partial {ℒ}_{a}}{\partial φ ( {x}_{i} )} = \frac{1}{{‖ φ ( {x}_{i} ) ‖}_{2}} ( \frac{{w}_{k}^{′ T}}{{‖ {w}_{k}^{′} ‖}_{2}} - \frac{{φ ( {x}_{i} )}^{T} cos {θ}_{i , k}}{{‖ φ ( {x}_{i} ) ‖}_{2}} ) \qquad Equation 6$$

In Equation 6, θ_{i,k} is the angle between w′ₖ and ϕ(xᵢ). Note that w′ₖ in this term is the parameter copied from wₖ, so there is no derivative to w′ₖ.

Some aspects use the weight vector in Softmax wₖ to represent the classification center. In some aspects, wₖ is updated (naturally during minimizing [symbol] ₛ) using not only the information from the k^{th} class, but also the information from the other classes. In contrast, cₖ is updated only using the information from the k^{th} class (calculated separately). More specifically, according to the derivative of the cross entropy loss shown in Equation 2, Equation 7 applies.

$$\frac{\partial {ℒ}_{s}}{\partial {w}_{k}} = {\sum }_{n} ( {p}_{k} ( {x}_{n} ) - {t}_{k , n} ) φ ( {x}_{n} ) \qquad Equation 7$$

Per Equation 7, the direction of wₖ is close to the direction of the face features from the k^{th} class, and being pushed far away from the directions of the face features not from the k^{th} class.

In sum, according to some implementations, an edge device accesses an input matrix. The edge device processes the input matrix through a plurality of convolution layers, each convolution layer including a convolution layer kernel, to generate a processed matrix. The convolution layer kernel is a first square, a side dimension of the first square being an integer greater than or equal to 2. The edge device processes the processed matrix through at least one squeeze layer, the at least one squeeze layer including a squeeze layer kernel, to generate an output matrix. The squeeze layer kernel is a second square with a side dimension of 1. The edge device provides a representation of the output matrix.

### NUMBERED EXAMPLES

Certain embodiments are described herein as numbered examples 1, 2, 3, etc. These numbered examples are provided as examples only and do not limit the subject technology.

Example 1 is a system comprising: processing hardware; and a memory storing instructions which cause the processing hardware to perform operations comprising: accessing an input matrix; processing the input matrix through a plurality of convolution layers from a neural network architecture, each convolution layer including a convolution layer kernel, to generate a processed matrix, the convolution layer kernel being a first square, a side dimension of the first square being an integer greater than or equal to 2; processing the processed matrix through at least one squeeze layer, the at least one squeeze layer including a squeeze layer kernel, to generate an output matrix, the squeeze layer kernel being a second square with a side dimension of 1, the at least one squeeze layer replacing at least one convolution layer from the neural network architecture; and providing a representation of the output matrix.

In Example 2, the subject matter of Example 1 includes, the operations further comprising: capturing an image; and generating the input matrix based on the captured image.

In Example 3, the subject matter of Example 2 includes, the operations further comprising: identifying, based on the output matrix and information stored in a data repository, a person or an object depicted in the captured image.

In Example 4, the subject matter of Examples 1-3 includes, wherein the at least one squeeze layer comprises exactly one squeeze layer that follows the plurality of convolution layers.

In Example 5, the subject matter of Examples 1-4 includes, wherein the at least one squeeze layer comprises a plurality of squeeze layers.

In Example 6, the subject matter of Examples 1-5 includes, wherein the input matrix and the output matrix have a same width, a same height, and different depths.

In Example 7, the subject matter of Examples 1-6 includes, wherein the side dimension of the first square is k, and wherein processing the input matrix through the plurality of convolution layers comprises, for each convolution layer: for each k*k block in the input matrix, computing a dot product of weights indicated in the convolution layer kernel and the k*k block; and providing the computed dot product for storage in a matrix provided to a next layer.

In Example 8, the subject matter of Examples 1-7 includes, wherein the plurality of convolution layers comprise four stages of convolution layers, and wherein the at least one squeeze layer comprises a single stage of squeeze layer.

In Example 9, the subject matter of Examples 1-8 includes, wherein the processing hardware and the memory reside within an edge device.

Example 10 is a non-transitory machine-readable medium storing instructions which cause one or more machines to perform operations comprising: accessing an input matrix; processing the input matrix through a plurality of convolution layers from a neural network architecture, each convolution layer including a convolution layer kernel, to generate a processed matrix, the convolution layer kernel being a first square, a side dimension of the first square being an integer greater than or equal to 2; processing the processed matrix through at least one squeeze layer, the at least one squeeze layer including a squeeze layer kernel, to generate an output matrix, the squeeze layer kernel being a second square with a side dimension of 1, the at least one squeeze layer replacing at least one convolution layer from the neural network architecture; and providing a representation of the output matrix.

In Example 11, the subject matter of Example 10 includes, wherein the at least one squeeze layer comprises exactly one squeeze layer that follows the plurality of convolution layers.

In Example 12, the subject matter of Examples 10-11 includes, wherein the at least one squeeze layer comprises a plurality of squeeze layers.

In Example 13, the subject matter of Examples 10-12 includes, wherein the input matrix and the output matrix have a same width, a same height, and different depths.

In Example 14, the subject matter of Examples 10-13 includes, wherein the side dimension of the first square is k, and wherein processing the input matrix through the plurality of convolution layers comprises, for each convolution layer: for each k*k block in the input matrix, computing a dot product of weights indicated in the convolution layer kernel and the k*k block; and providing the computed dot product for storage in a matrix provided to a next layer.

In Example 15, the subject matter of Examples 10-14 includes, wherein the plurality of convolution layers comprise four stages of convolution layers, and wherein the at least one squeeze layer comprises a single stage of squeeze layer.

Example 16 is a method comprising: accessing an input matrix stored in memory; processing, at a processing hardware, the input matrix through a plurality of convolution layers from a neural network architecture, each convolution layer including a convolution layer kernel, to generate a processed matrix, the convolution layer kernel being a first square, a side dimension of the first square being an integer greater than or equal to 2; processing, at the processing hardware, the processed matrix through at least one squeeze layer, the at least one squeeze layer including a squeeze layer kernel, to generate an output matrix, the squeeze layer kernel being a second square with a side dimension of 1, the at least one squeeze layer replacing at least one convolution layer from the neural network architecture; and providing, via a computer bus or a network interface, a representation of the output matrix.

In Example 17, the subject matter of Example 16 includes, wherein the at least one squeeze layer comprises exactly one squeeze layer that follows the plurality of convolution layers.

In Example 18, the subject matter of Examples 16-17 includes, wherein the at least one squeeze layer comprises a plurality of squeeze layers.

In Example 19, the subject matter of Examples 16-18 includes, wherein the side dimension of the first square is k, and wherein processing the input matrix through the plurality of convolution layers comprises, for each convolution layer: for each k*k block in the input matrix, computing a dot product of weights indicated in the convolution layer kernel and the k*k block; and providing the computed dot product for storage in a matrix provided to a next layer.

In Example 20, the subject matter of Examples 16-19 includes, wherein the plurality of convolution layers comprise four stages of convolution layers, and wherein the at least one squeeze layer comprises a single stage of squeeze layer.

In Example 21, the subject matter of Examples 16-20 includes, introducing a regularizer to cross entropy loss for multinomial logistic regression (MLR) learning, the regularizer encouraging directions of face features from a same class to be proximate to a direction of a corresponding classification weight vector in a logistic regression.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

### Components and Logic

Certain embodiments are described herein as including logic or a number of components or mechanisms. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

Accordingly, the phrase “hardware component” should be understood to encompass a tangible record, be that an record that is physically constructed, permanently configured (e.g., hardwired), or temporarily configured (e.g., programmed) to operate in a certain manner or to perform certain operations described herein. As used herein, “hardware-implemented component” refers to a hardware component. Considering embodiments in which hardware components are temporarily configured (e.g., programmed), each of the hardware components might not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

### Example Machine and Software Architecture

The components, methods, applications, and so forth described in conjunction with FIGS. 1-4 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the disclosed subject matter in different contexts from the disclosure contained herein.

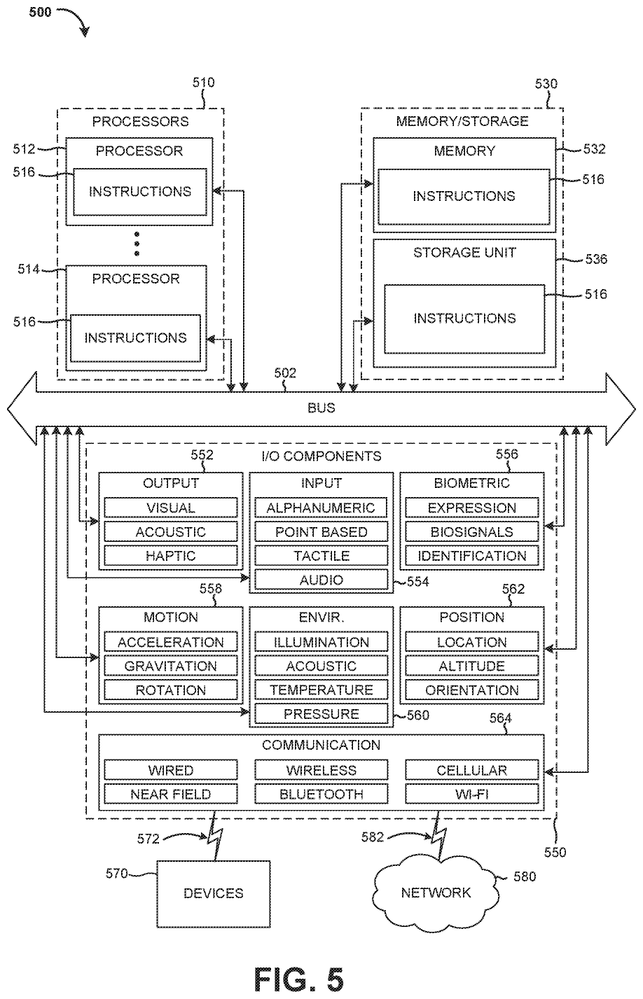

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. The instructions 516 transform the general, non-programmed machine into a particular machine programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, PC, a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory/storage 530, and I/O components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 512 and a processor 514 that may execute the instructions 516. The term “processor” is intended to include multi-core processors that may comprise two or more independent processors (sometimes referred to as “cores”) that may execute instructions contemporaneously. Although FIG. 5 shows multiple processors 510, the machine 500 may include a single processor with a single core, a single processor with multiple cores (e.g., a multi-core processor), multiple processors with a single core, multiple processors with multiples cores, or any combination thereof.

The memory/storage 530 may include a memory 532, such as a main memory, or other memory storage, and a storage unit 536, both accessible to the processors 510 such as via the bus 502. The storage unit 536 and memory 532 store the instructions 516 embodying any one or more of the methodologies or functions described herein. The instructions 516 may also reside, completely or partially, within the memory 532, within the storage unit 536, within at least one of the processors 510 (e.g., within the processor's cache memory), or any suitable combination thereof, during execution thereof by the machine 500. Accordingly, the memory 532, the storage unit 536, and the memory of the processors 510 are examples of machine-readable media.

As used herein, “machine-readable medium” means a device able to store instructions (e.g., instructions 516) and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine (e.g., processors 510), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion and the grouping is in no way limiting. In various example embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), measure exercise-related metrics (e.g., distance moved, speed of movement, or time spent exercising) identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via a coupling 582 and a coupling 572, respectively. For example, the communication components 564 may include a network interface component or other suitable device to interface with the network 580. In further examples, the communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a USB).

Moreover, the communication components 564 may detect identifiers or include components operable to detect identifiers. For example, the communication components 564 may include Radio Frequency Identification (RFID) tag reader components, NFC smart tag detection components, optical reader components, or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

In various example embodiments, one or more portions of the network 580 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 580 or a portion of the network 580 may include a wireless or cellular network and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 4G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., HTTP). Similarly, the instructions 516 may be transmitted or received using a transmission medium via the coupling 572 (e.g., a peer-to-peer coupling) to the devices 570. The term “transmission medium” shall be taken to include any intangible medium that is capable of storing, encoding, or carrying the instructions 516 for execution by the machine 500, and includes digital or analog communications signals or other intangible media to facilitate communication of such software.

What is claimed is:

1. A system comprising:
processing hardware; and
a memory storing instructions which cause the processing hardware to perform operations comprising:
accessing an input matrix;
processing the input matrix through a plurality of convolution layers from a neural network architecture, each convolution layer including a convolution layer kernel, to generate a processed matrix, the convolution layer kernel being a first square, a side dimension of the first square being an integer greater than or equal to 2;
processing the processed matrix through at least one squeeze layer, the at least one squeeze layer including a squeeze layer kernel, to generate an output matrix, the squeeze layer kernel being a second square with a side dimension of 1, the at least one squeeze layer replacing at least one convolution layer from the neural network architecture; and
providing a representation of the output matrix.

2. The system of claim 1, the operations further comprising:
capturing an image; and
generating the input matrix based on the captured image.

3. The system of claim 2, the operations further comprising:
identifying, based on the output matrix and information stored in a data repository, a person or an object depicted in the captured image.

4. The system of claim 1, wherein the at least one squeeze layer comprises exactly one squeeze layer that follows the plurality of convolution layers.

5. The system of claim 1, wherein the at least one squeeze layer comprises a plurality of squeeze layers.

6. The system of claim 1, wherein the input matrix and the output matrix have a same width, a same height, and different depths.

7. The system of claim 1, wherein the side dimension of the first square is k, and wherein processing the input matrix through the plurality of convolution layers comprises, for each convolution layer:
for each k*k block in the input matrix, computing a dot product of weights indicated in the convolution layer kernel and the k*k block; and
providing the computed dot product for storage in a matrix provided to a next layer.

8. The system of claim 1, wherein the plurality of convolution layers comprise four stages of convolution layers, and wherein the at least one squeeze layer comprises a single stage of squeeze layer.

9. The system of claim 1, wherein the processing hardware and the memory reside within an edge device.

10. A non-transitory machine-readable medium storing instructions which cause one or more machines to perform operations comprising:
accessing an input matrix;
processing the input matrix through a plurality of convolution layers from a neural network architecture, each convolution layer including a convolution layer kernel, to generate a processed matrix, the convolution layer kernel being a first square, a side dimension of the first square being an integer greater than or equal to 2;
processing the processed matrix through at least one squeeze layer, the at least one squeeze layer including a squeeze layer kernel, to generate an output matrix, the squeeze layer kernel being a second square with a side dimension of 1, the at least one squeeze layer replacing at least one convolution layer from the neural network architecture; and
providing a representation of the output matrix.

11. The machine-readable medium of claim 10, wherein the at least one squeeze layer comprises exactly one squeeze layer that follows the plurality of convolution layers.

12. The machine-readable medium of claim 10, wherein the at least one squeeze layer comprises a plurality of squeeze layers.

13. The machine-readable medium of claim 10, wherein the input matrix and the output matrix have a same width, a same height, and different depths.

14. The machine-readable medium of claim 10, wherein the side dimension of the first square is k, and wherein processing the input matrix through the plurality of convolution layers comprises, for each convolution layer:
for each k*k block in the input matrix, computing a dot product of weights indicated in the convolution layer kernel and the k*k block; and
providing the computed dot product for storage in a matrix provided to a next layer.

15. The machine-readable medium of claim 10, wherein the plurality of convolution layers comprise four stages of convolution layers, and wherein the at least one squeeze layer comprises a single stage of squeeze layer.

16. A method comprising:
accessing an input matrix stored in memory;
processing, at a processing hardware, the input matrix through a plurality of convolution layers from a neural network architecture, each convolution layer including a convolution layer kernel, to generate a processed matrix, the convolution layer kernel being a first square, a side dimension of the first square being an integer greater than or equal to 2;
processing, at the processing hardware, the processed matrix through at least one squeeze layer, the at least one squeeze layer including a squeeze layer kernel, to generate an output matrix, the squeeze layer kernel being a second square with a side dimension of 1, the at least one squeeze layer replacing at least one convolution layer from the neural network architecture; and
providing, via a computer bus or a network interface, a representation of the output matrix.

17. The method of claim 16, wherein the at least one squeeze layer comprises exactly one squeeze layer that follows the plurality of convolution layers.

18. The method of claim 16, wherein the at least one squeeze layer comprises a plurality of squeeze layers.

19. The method of claim 16, wherein the side dimension of the first square is k, and wherein processing the input matrix through the plurality of convolution layers comprises, for each convolution layer:
for each k*k block in the input matrix, computing a dot product of weights indicated in the convolution layer kernel and the k*k block; and
providing the computed dot product for storage in a matrix provided to a next layer.

20. The method of claim 16, wherein the plurality of convolution layers comprise four stages of convolution layers, and wherein the at least one squeeze layer comprises a single stage of squeeze layer.

21. The method of claim 16, further comprising:
introducing a regularizer to cross entropy loss for multinomial logistic regression (MLR) learning, the regularizer encouraging directions of face features from a same class to be proximate to a direction of a corresponding classification weight vector in the multinomial logistic regression.
